(19) United States
(12) Patent Application Publication
(10) Pub. No.: US 2004/0191572 A1
(43) Pub. Date: Sep. 30, 2004

(54) UV/EB cured integrated magnets-composition and method of fabrication

(75) Inventors: Xinhao Gao, E. Amherst, NY (US); Scott D. Goldstein, Highland Park, IL (US); Anshyang Albert Lin, Getzville, NY (US); Richard William Johnston, Ft. Erie (CA)

Correspondence Address: MCANDREWS HELD & MALLOY, LTD, 500 WEST MADISON STREET, SUITE 3400, CHICAGO, IL, 60661

(73) Assignee: Sovereign Specialty Chemical, Inc.

(21) Appl. No.: 10/817,653

(22) Filed: Apr. 2, 2004

Related U.S. Application Data
(63) Continuation of application No. 10/184,867, filed on Jun. 28, 2002.

(51) Int. Cl. G11B 5/66

(52) U.S. Cl. 428/694 BA; 428/694 BC; 428/694 R

(57) ABSTRACT

The present invention comprises a radiation curable composition for in-line printing containing magnetic pigments capable of being magnetized to possess permanent magnetic properties after the composition is cured. The composition is cured by an ionizing radiation source, preferably by UV light or electron beam radiation (UV/EB). The present invention is also directed to an in-line process for printing magnetic images on non-magnetic substrate, comprising: pattern applying the above mentioned radiation curable composition on the substrate opposite to a print side, pre-aligning the magnetic pigment particles (if necessary) of the applied composition, curing the composition by ionizing radiation source (UV/EB), magnetizing the cured composition, then finishing the final piece. The finishing step could involve delivering the final piece in a simple sheet with die cut magnets or creating an “integrated magnet” format involving plow folding over the magnet panel, pattern coating or flood coating an adhesive that will only adhere the non-magnet matrix areas between die cut magnets, thus, allowing for the individual magnets to be “popped” out of the carrier by the final end user. The resulting magnetized pieces will possess holding power like magnets (refrigerator and office magnets) and are capable of carrying personalized, Scitex imaged and direct marketing information (including redemption value for coupons, local public service access numbers, etc.)

### I. BACKGROUND

A. Field of the Invention

The present invention has multiple aspects. In its simplest aspect, it is directed to a radiation curable composition for in-line printing and containing magnetic particles capable of being magnetized to possess permanent magnetic properties when the composition is cured. In its second aspect, the present invention is directed to an in-line process for printing magnetic images on non-magnetic substrate, comprising: pattern applying the above mentioned radiation curable composition on the substrate, typically opposite to a print side, pre-aligning the magnetic pigment particles (if necessary) of the applied composition, curing the composition by ionizing radiation source (UV/EB), magnetizing the cured composition, and then finishing the final piece. In its third aspect, the present invention is directed to a non-magnetic substrate having a radiation cured magnetic coating adhering to at least one side.

B. Background of the Invention

Refrigerator and office magnets generally comprise of a magnetic (magnetized) layer laminated with an adhesive layer to a non-magnetic substrate (see FIG. 1). The magnetic layer comprises of a rubbery, polymeric binder and magnetic pigments such as ferrites as known in the art. This magnetic layer is generally made as a sheet or a strip in a separate process where the above-mentioned binder and pigment mixture is softened or melted with heat and extruded to form a continuous web. The alignment of magnetic particles is then conducted while the web is still warm and can allow for some mobility and the web is then cooled and magnetized (charged) with charging magnets. At the converter, this magnetic web is then converted into individual magnets, through slitting and/or die cutting (through the ferrite layer), of various sizes and shapes. In another separate process, the non-magnetic substrate is usually printed on to create some type of graphical or text images. In a separate process or in the same print process, as described in the following patents (U.S. Pat. No. 6,024,277; U.S. Pat. No. 5,924,624, U.S. Pat. No. 5,868,498; U.S. Pat. No. 5,676,307; U.S. Pat. No. 5,641,116, and U.S. Pat. No. 5,458,282), the pre-processed, or pre-sheeted or pre-die-cut magnetic pieces are affixed to the desired locations on the non-magnetic substrate with the use of some form of adhesive to form a substrate/adhesive/magnet laminate as shown in FIG. 1. However, the described processes do not address the on-demand shape and size needs, the upstream processing waste, the multiple steps required for the pre-processed magnetic pieces, or the die cutting problems associated with the production, processing, and finishing of traditional magnets.

Specifically, the above-mentioned prior art processes for processing and finishing refrigerator and office magnets have a number of drawbacks. For example, they require multiple steps and multiple converters to complete the finishing of the magnetic pieces. There are also multiple bottlenecks for production speed and efficiency. Specifically, the above-mentioned processes restrict the sizes and shapes of the design artwork and cannot accommodate the immediate design needs of the customer. Moreover, the above-described processes limit the flexibility, quantity, and capability of mass production of magnets that also carry personalized information or advertising since the traditional vinyl magnet substrate is not a good receptor of imaging inks used in personalization as well as the inherent thermal instability of the vinyl substrate itself (this being a problem due to high heat associated with personalized imaging). Because the ferrite magnet is overlaid to the entire surface of the substrate, the above-described prior art methods create a lot of trimming and die-cutting waste, particularly magnetic waste. Likewise, because the dies have to cut through the traditional magnet layer (typically 8-15 mils/200-375μ thick), which is almost always harder than the substrate layer(s), the dies have a short life and require frequent replacement.

U.S. Pat. No. 5,682,670 (Bell) describes a method for the fabrication of multipole permanent magnet components for motor, capacitor applications with a screen-printable and thermal curable magnet containing inks. Even though Bell utilized printable and curable magnetic compositions to create predetermined pattern using a screen printing process, the compositions disclosed in Bell presents several problems for a in-line process. Specifically, the curable magnetic inks disclosed in Bell are thermally cured and require an extensive cure profile, such as 100 degree C. and 30-60 minutes. (See Bell at Example 1.) For an in-line process, the curing schedule requires that any printed composition needs to be dried and cured well within a minute to be usable. Bell also requires a laminating process to combine two such printed sheets charged to different polarity (north pole and south pole) to create a multipole magnet. Further, the method disclosed in Bell, can only deal with sheet-fed type operation due to the curing schedule and the subsequent laminating process. Finally, the curable composition in Bell is designed for motor type application is too hard and not flexible enough for a typical in-line printing equipment where the cured web/sheet with magnets has to wrap around and move along over sets of moving rollers to be processed.

### II. SUMMARY OF THE INVENTION

The Applicants have discovered a radiation curable magnetic composition that is suitable for pattern applied coating application methods. The resulting composition allows for the creation of magnetic pieces of various shapes and areas, and eliminates the need for die cutting through the magnetic composition, thereby reducing cost and extending the life of the dies. The above-mentioned radiation curable magnetic composition was applied directly to one surface of a non-magnetic substrate (“substrate”) and cured to create a new adhesiveless magnet, i.e., an “integrated magnet”.

The resulting integrated magnets will possess holding power like magnets (refrigerator and office magnets) and are capable of carrying personalized, Scitex imaged and direct marketing information (including redemption value for coupons, local public service access numbers, etc.). An example of the integrated magnet is shown in FIG. 3. The integrated magnets were made with pre-designed shape or pattern; and thus, totally eliminate the trim waste generated by processing the conventional refrigerator and office magnet sheets or webs. The integrated magnets of the present invention were made with the magnetic layer having a thickness that was thinner than the magnetic (e.g., ferrite) sheets used in conventional refrigerator and office magnets. Because the magnetic component is most often the heaviest component of a refrigerator magnet or an office magnet, the thinner magnets of the present invention have lower weight, and thus, reduced shipping costs.

The above mentioned radiation curable magnetic composition is preferably used in an in-line finishing process, comprising some or all of the many in-line sub-processes including color image printing, personalized information printing through a computer generated imaging system from Scitex, magnetic coating application (on opposite side of the substrate to the printed images), magnetic particle alignment, ionizing radiation curing of the magnetic coating, magnetization of magnetic coating, die-cutting around magnetic image pattern, plow-folding the substrate into a final design, adhesive application for purposes other than delivering magnets to the substrate, sorting the final pieces, and other sub-processes known in the art of in-line printing. (See FIG. 2).

Thus, the present invention has multiple aspects. In its first aspect, it is directed to a radiation curable magnetic composition suitable for in-line printing comprising from 50 to 95 weight % of magnetic particles having an average particle size ranging from 1 micron (μ) to 200μ, in combination with 50 to 5 weight % of a radiation curable resin, said radiation curable magnetic composition having a viscosity within the range of 50 cps to 10,000 cps. The. radiation curable magnetic composition of the present invention is useful in coating the surface of a non-magnetic substrate, so as to render the non-magnetic substrate capable of adhering to an iron based object, such as a household appliance (e.g., refrigerator, stove, washing machine, furnace) or a metal filing cabinet.

The radiation curable magnetic composition of the present invention has several advantages over the prior art, including a reduced thickness (up to 70% thinner than standard vinyl ferrite “refrigerator magnets”); a reduced shipping weight (up to 70% lighter weight than the standard vinyl ferrite magnets); can be pattern applied to printable magnet pieces (thereby, reducing manufacturing and shipping costs); reduces waste (with the UV/EB curable magnetic media being pattern applied, trim waste is eliminated 100%); useable in in-line processing (so that the UV/EB curable magnetic composition can be integrated into a direct mail advertisement piece); allows “personalization” via Scitex Imaging (by allowing for specific names, phone numbers, redemption values to be printed on each individual magnet); no lamination of face stock to magnets (no adhesive required); reduces processing cost (magnets can be produced on web widths as wide as 40″ at processing speeds up to 800 fpm); and reduces die-cutting wear (via pattern application a 1/16″ border can surround the produced magnet; thus, eliminating the need to die cut directly through the magnet surface).

In its second aspect, the present invention is directed to a method for selectively applying a magnetic surface to a non-magnetic substrate, comprising:

a. combining magnetic particles having an average size within the range of 1μ to 200μ, with a radiation curable resin to form a radiation curable magnetic coating composition;

b. pattern applying a layer of the radiation curable magnetic coating composition directly to a predetermined portion of a surface of a non-magnetic substrate, said layer having a thickness within the range of 0.4 mils to 20 mils upon curing.

Preferably, the magnetic particles having an average size within the range of 10μ to 80μ; more preferably, the magnetic particles having an average size within the range of 20μ to 70μ.

In its third aspect, the present invention is directed to a method for making an adhesive-free laminated product suitable for adhering by magnetic attraction to an iron based surface, comprising:

a. combining from 50 to 95 weight % of magnetic particles having an average size within the range of 1μ to 200μ, with 50 to 5 weight % of a radiation curable resin, and an effective amount of a curing agent, to form a radiation curable magnetic coating composition;

b. pattern applying a layer of the radiation curable magnetic coating composition directly to a predetermined portion of a surface of a non-magnetic substrate; and

c. curing said pattern applied radiation curable magnetic coating composition to form a laminated product having a magnetic coating adhered to a predetermined portion of said non-magnetic substrate.

Preferably, before, during or after said curing step, said magnetic particles in said radiation curable magnetic coating composition are magnetically charged to increase the strength of their magnetic field.

In its final aspect, the present invention is directed to a composite object comprising a non-magnetic substrate having at least one surface to which is directly adhered a layer of a radiation cured magnetic resin comprising 50 to 95 weight % of magnetic particles having an average size within the range of 1μ to 200μ, dispersed within 50 to 5 weight % of a radiation cured resin.

### III. BRIEF DESCRIPTION OF THE FIGURES

FIG. 1 is a cross sectional drawing of a composite material of the prior art, such as a refrigerator or office magnet, showing that a non-magnetic layer (or a non-magnetic substrate) is bound to a magnetic layer by an adhesive layer.

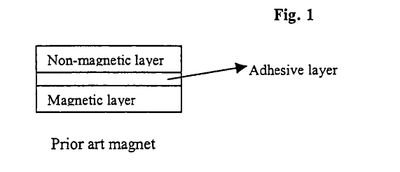

FIG. 2 is a block diagram of the “In-Line Process” of the present invention, beginning with a non-magnetic substrate that is passed through the following stations: 1) ink printing stations and drying ovens; 2) application station for the radiation curable magnetic resin composition; 3) optional magnetic particle (pigment) alignment station; 4) curing (UV/EB) station for the radiation curable magnetic resin composition; 5) optional drying oven; 6) magnetization station for magnetizing the magnetic particles in the magnetic resin composition; and 7) optionally, a die cut, sorting and collection station.

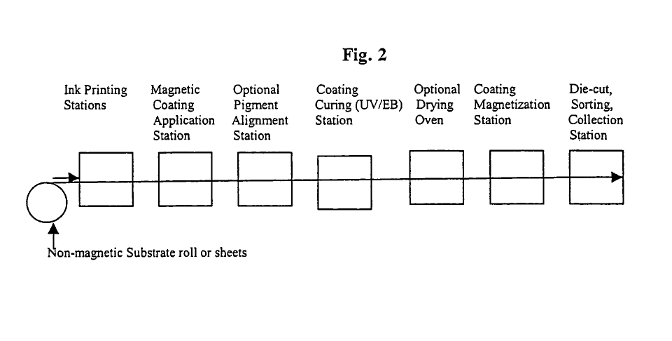

FIG. 3 is a cross-sectional view of two different composite objects (integrated magnets) of the present invention, such as made by the in-line process of FIG. 2. At the left end of the non-magnetic substrate, there is shown one embodiment of a precursor to a composite object of the present invention wherein the non-magnetic substrate, having two opposing surfaces, has ink images and text on one opposing surface and a cured magnetic resin coating (“magnetic coating layer”) on the other opposing surface. At the right end of the non-magnetic substrate, there is shown a second embodiment of a precursor to a composite object of the present invention wherein the non-magnetic substrate, having two opposing surfaces, has a plurality of ink images and text on one opposing surface and a plurality of cured magnetic resin coatings (“magnetic coating layers”) on the other opposing surface. The die cut lines are shown as extending from about 0 to ⅛ inch beyond the precise pattern applied magnetic coating layers so as to avoid cutting through the magnetic coating layer(s), thereby extending the life of the die.

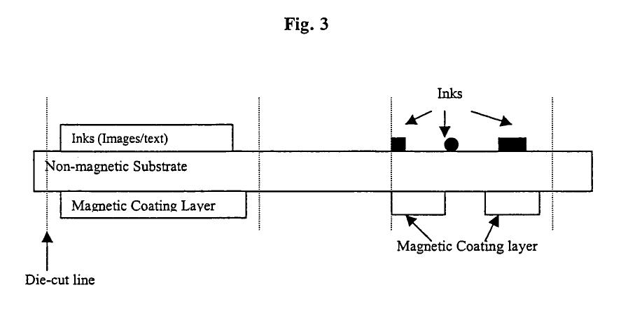

FIGS. 4A and 4B depicts two multiple pole magnet arrangements for a magnetization or charging roller that is used to charge the magnetic particles in the in-line process of the present invention. In FIG. 4A, the North and South poles of the multiple pole magnet alternate on the outer surface of the roller and run parallel to the axis of rotation of the roller (which is perpendicular to the direction of rotation of the roller). In FIG. 4B, the North and South poles of the multiple pole magnet alternate on the outer surface of the roller and run perpendicular to the axis of rotation of the roller (which is in the direction of the rotation). In FIGS. 4A and 4B, the North poles are shown as the solid lines (______), and the South poles are shown as the broken lines ( - - - ).

### IV. DETAILED DESCRIPTION OF THE INVENTION

The present invention has multiple aspects. In its first aspect, it is directed to a radiation curable magnetic composition suitable for in-line printing comprising from 50 to 95 weight % of magnetic particles having an average particle size ranging from 1 micron (μ) to 200μ, in combination with 50 to 5 weight % of a radiation curable resin, said radiation curable magnetic composition having a viscosity within the range of 50 cps to 10,000 cps. The radiation curable magnetic composition of the present invention is useful in coating the surface of a non-magnetic substrate, so as to render the non-magnetic substrate capable of adhering to an iron based object, such as a household appliance (e.g., refrigerator, stove, washing machine, furnace) or a metal filing cabinet.

Magnetic Particles (Pigments/Powders):

The first component of the radiation curable magnetic composition of the present invention is magnetic particles having an average particle size ranging from 1 micron (μ) to 200μ. There are four basic classes of permanent magnetic particles (pigments/powders) that are suitable for use in the present invention, namely, Alnico alloys, ceramic, rare-earth alloys, and iron-chromium-cobalt alloys as described in the “Standard Specifications for Permanent Magnet Materials” published by Magnetic Materials Producers Association on www.mmpa.org. The magnetic materials suitable for use in this invention include the Alinco alloys which consist of various compositions of aluminum, nickel, cobalt, copper, iron and titanium, where in some grades, the cobalt and titanium are omitted. (E.g., Alnico 1, 2, 3, 5, 5DG, 5-7, 6, 8, 8HC, 9). The coercive force of the Alinco magnets, as a function of composition, are shown below:

COMPOSITION (% of each component)¹

| | | | | | | Coercive |
|---|---|---|---|---|---|---|
| | | | | | | Force |
| Name | Al | Ni | Co | Cu | Ti | (oersteds) |
| Alinco 1 | 12 | 21 | 5 | 3 | — | 470 |
| Alinco 2 | 10 | 19 | 13 | 3 | — | 560 |
| Alinco 3 | 12 | 25 | — | 3 | — | 480 |
| Alinco 5 | 8 | 14 | 24 | 3 | — | 640 |
| Alinco | 8 | 14 | 24 | 3 | — | 670 |
| 5DG | | | | | | |
| Alinco 5-7 | 8 | 14 | 24 | 3 | — | 740 |
| Alinco 6 | 8 | 16 | 24 | 3 | — | 780 |
| Alinco 8 | 7 | 15 | 35 | 4 | 5 | 1650 |
| Alinco | 8 | 14 | 38 | 3 | 8 | 1900 |
| 8HC | | | | | | |
| Alinco 9 | 7 | 15 | 35 | 4 | 5 | 1500 |

Ceramic magnets have the general formula of MO.6Fe₂O₃, where M=barium or strontium or any combination of the two. The ceramic magnets have three times the coercive force of the magnets formed from the Alinco alloys. Examples of ceramic magnets are shown below:

| MMPA Brief | Original | Coercive |
|---|---|---|
| Designation | MMPA Class | Force (oersteds) |
| 1.0/3.3 | Ceramic 1 | 1860 |
| 3.4/2.5 | Ceramic 5 | 2400 |
| 2.7/4.0 | Ceramic 7 | 3250 |
| 3.5/3.1 | Ceramic 8 | 2950 |
| 3.4/3.9 | — | 3400 |
| 4.0/2.9 | — | 2800 |
| 3.2/4.8 | — | 3500 |
| 3.8/4.0 | — | 3650 |

¹Balance is iron in all alloys

The rare-earth magnets fall into three different types, depending upon their composition, and have some of the highest coercive forces. The three types of magnets are the “rare earth cobalt 5” magnets, the “rare earth 2 transition metal 17” group and the “rare earth iron alloys.” The rare earth cobalt 5 alloys are usually binary or ternary alloys with the approximate atomic ratio of one rare earth atom to five cobalt atoms. The rare earth element most commonly used is samarium. However, light rare earths, such as praseodymium, cerium, neodymium or a combination thereof, may also be used. To give the alloy a lower temperature coefficient of remanence, the heavy rare earths, such as gadolinium, dysprosium and erbium, are substituted for the light rare earths. In the rare earth cobalt 5 magnets, the rare earth elements typically make up 34 to 39 weight % of the alloy. The coercive forces of the rare earth cobalt 5 magnets range from 7500 to 9000 oersteds.

The rare earth 2 transition element 17 alloys have a ratio of 2 rare earth atoms to 13-17 transition metal elements (RE₂TM₁₇). The rare earth elements are one or more elements selected from the group consisting of praseodymium, cerium, neodymium, gadolinium, dysprosium and erbium. The transition metal is a combination of cobalt, iron and copper. The rare earth content of these alloys is typically 23 to 28 weight %. The coercive forces of these alloys range from about 6000 to 10600 oersteds.

The rare earth iron alloys have a composition ratio consisting of two rare earth elements to 14 iron atoms and one boron atom (RE₂TM₁₄B). The rare earth elements are one or more elements selected from the group consisting of praseodymium, cerium, neodymium, gadolinium, dysprosium and erbium. Cobalt may be substituted for iron at 3 to 15 weight %. The rare earth content of these alloys is 30 to 35 weight %. These alloys have the highest coercive forces of any of the rare earth alloys, ranging from 9600 to 13000 oersteds.

Preferred magnetic particles for use in the present invention comprise the rare earth cobalt 5 alloys, the rare earth 2 transition metal 17 alloys (RE₂TM₁₇) or the rare earth iron alloys (RE₂TM₁₄B). More preferred magnetic particles for use in the present invention comprise the rare earth 2 transition metal 17 alloys (RE₂TM₁₇) or the rare earth iron alloys (RE₂TM₁₄B). Most preferred magnetic particles comprise the rare earth iron alloy (RE₂TM₁₄B).

Other magnetic particles that may be used in the present invention include the iron-chromium-cobalt alloys (general class of FeCrCo 1, FeCrCo 2, FeCrCo, FeCrCo 5, FeCrCo 250, FeCrCo 640). Some grades may also vanadium, silicon, titanium, zirconium, manganese, molybdenum or aluminum. However, the coercive forces of these magnets range from 200 to 490 oersteds. Hence, they are from 13 up to 26 times weaker than magnets made from the rare earth alloys described above.

The particle size of the magnetic materials should match the coating application methods mentioned in the section below. Typically, the magnetic particles have an average size of between 1 micron (μ) and 200μ, more typically between 10μ and 80μ, most typically between 20 and 70μ. In certain instances, the average particle size of the magnetic particles will depend upon the in-line printing method that is utilized. For the most preferable coating method, rotary screen, a the upper end of the preferred average particle size should be less than 150 mesh (106 microns), more preferably, the average particle size should be less than 70 microns.

Examples of the commercial available magnetic materials of the preferable magnetic material type include MQP-B, MQP-B+, MQP-C, MQP-D, MQP-O, MQP-S-9-8, MQP-S-11-9, MQP13-9, MQP15-7 from Magnequench International, Inc.; NL-3, NL-3.3, NL-4, NL-4.5 from Pioneer Metals and Technology, Inc. The most preferable commercial available magnetic materials include MQP-S-9-8 and MQP-S-11-9.

Radiation Curable Binder

The second component of the radiation curable magnetic composition is a radiation curable resin, said radiation curable magnetic composition having a viscosity within the range of 50 cps to 10,000 cps. The radiation curable binder was disclosed by exposing it to an ionizing radiation source, such as visible light, ultraviolet (UV) light, and electron beam (EB) ionizing radiation. A preferred ionizing radiation source is UV light due to lower equipment costs.

The radiation curable binder is typically cured by any one of three systems. The three systems include a free radical system, a cationic curable system, and hybrid system that is a combination of the free radical and cationic systems. Selection of the radiation curable materials will depend on the cure mechanism. The free radical curing mechanism is most preferred due to its lower moisture sensitivity and better storage stability.

The radiation curable binder is comprised of (1) 20-100 wt % of radiation curable compounds (e.g. polymers, oligomers, monomers), (2) 0-15 wt % of photo-initiators (monomeric, oligomeric, and polymeric type) which are optional for the electron beam cure systems, (3) 0-60 wt % of non-radiation curable compounds (e.g. plasticizers, non-radiation curable polymers and pre-polymers, tackifier resins that are mixable with or soluble in the radiation curable portion), (4) 0-5 wt % of one or more of the additives assisting in wetting/leveling, defoaming, dispersing the magnetic powder, rheology control, and thermal stability, and (5) 0-80 wt % of viscosity reduction or diluting solvents and/or water (if the radiation curable ingredients used are either mixable with, dispersible in or soluble in water),

A radiation curable compound is a polymer, oligomer or monomer that has at least one radiation curable functional group. A radiation curable functional group comprises at least one site of ethylenic unsaturation for a free radical curing system; or an epoxide and a hydroxyl functionality for a cationic curing system; and a combination of ethylenic unsaturation, epoxide and hydroxyl functionality for a hybrid system. Preferred radiation curable compounds are those that have ethylenic unsaturation. Examples of each type of compounds are listed below.

1. Ethylenic Unsaturation for Radiation Curable Free Radical and Hybrid Systems:

A radiation curable ethylenic unsaturated compound is a compound having at least one ethylenically unsaturated bond (C═C) in the molecule. Examples of suitable ethylenic unsaturation include, but not limited to, acrylates, methacrylates, N-substituted acrylamides, vinyl ethers, vinyl esters, styrene, vinyl amides, maleate esters, fumarate esters, and vinyl melamines. Preferably the ethylenic groups are composed of either acrylates, methacrylates or mixtures of thereof and will be designated herein as by the term “(meth)acrylates.” The (meth)acrylates include monomeric, oligomeric, and polymeric types with the functional group:

CH₂═C(R)—COO—;

wherein when R═H, the molecule is an acrylate; and when R═CH₃, the molecule is a methacrylate.

The monomeric (meth)acrylates used in the present invention are monofunctional, difunctional, trifunctional or multifunctional. Examples of mono-functional (meth)acrylates include isobonyl (meth)acrylate, isodecyl (meth)acrylate, cyclic trimethylolpropane formal acrylate, lauryl (meth)acrylate, 2-phenoxyethyl (meth)acrylate, stearyl (meth)acrylate, tetrahydrofurfuryl (meth)acrylate, tridecyl (meth)acrylate, nonyl phenol (meth)acrylate, ethoxy nonyl phenol (meth)acrylate, 2-(2-ethoxyethoxy) ethyl acrylate, caprolactone (meth)acrylate, and various ethoxylated hydroxyethyl methacrylates.

Examples of difunctional (methyl)acrylates include 1,4-butanediol di(meth)acrylate, 1,3 butylene glycol di(meth)acrylate, cyclohexane dimethanol di(meth)acrylate, ethylene glycol di(meth)acrylate, dipropylene glycol diacrylate, various ethoxylated bisphenol A di(meth)acrylates, 1,6 hexanediol di(meth)acrylate, neopentyl glycol di(meth)acrylate, polyethylene glycol (200) di(meth)acrylate, polyethylene glycol (400) di(meth)acrylate, polyethylene glycol di(meth)acrylate, propoxylated neopentyl glycol diacrylate, tetraethylene glycol di(meth)acrylate, and triethylene glycol di(meth)acrylate.

Examples of trifunctional (meth)acrylates include trimethylolpropane tri(meth)acrylate, various ethoxylated trimethylolpropane tri(meth)acrylate, pentaerythritol triacrylate, proxylated glyceryl tri(meth)acrylate, and tris-(2-hydroxyethyl)isocyanurate triacrylate.

Examples of multifunctional (meth)acrylates such as dipentaerythritol pentaacrylate, di-trimethylol tetraacrylate, ethoxylated pentaerythritol tetraacrylate, pentaerythritol tetraacrylate, alkoxylated pentaerythritol tetraacrylate; other adhesion promoting (meth)acrylates such as CD9050, 9051, 9052, SR9008, 9016, 9012, 9009, 9011 are commercially available from Sartomer; EBECRYL 168 and 170 is available from UCB Chemicals, GENOMER 7154 from Rahn, N-vinylpyrrolidone, N-vinyl caprolactam from ISP, and carboxylic acid containing (meth)acrylated derived from reaction adducts of anhydride and hydroxy (meth)acrylates such as adducts of succinic anhydride & 2-hydroxyethylacrylate, of phthalic anhydride & 2-hydroxyethylacrylate, and the like as listed in patent WO 01/02507. Di, tri- and multi-functional diluents, like trimethylolpropane triacrylate, can increase cure speed and crosslink density.

Oligomeric (meth)acrylates usually, but not always, have higher molecular weight and higher viscosity than the monomeric (meth)acrylates and are generally film forming components. Their molecular weight can range from 300 grams/mole to 20,000 grams/mole or higher. The chemical structure/nature of these (meth)acrylate containing compounds includes, but not limited to, Epoxy (meth)acrylates (such as EBECRYL 600, 645, 648, 860, 2005, 3200,3201, 3211, 3212, 3302, 3411, 3412, 3500, 3600, 3603, 3605, 3700, 3701, 3702, 3703, 37087, 3720 from UCB Chemicals; CN104, 111, 112, 115, 116, 117, 118, 119, 120, 121, 124, 136 from; PHOTOMER 3000 series from Cognis; LAROMER LR8765, 8986 from BASF; ACTILANE 300, 310, 320, 330, 340, 360 from Akzo Nobel); Aliphatic polyurethane (meth)acrylates (examples as listed in the product brochures from Akzo Nobel, BASF, Cognis, Sartomer, UCB); Aromatic polyurethane (meth)acrylates (examples as listed in the product brochures from Akzo Nobel, BASF, Cognis, Sartomer, UCB); Polyester (meth)acrylates(examples as listed in the product brochures from Akzo Nobel, BASF, Cognis, Sartomer, UCB); Acrylic acrylates (EBECRYL 740, 745, 754, 1701, 1710 from UCB;); Triazine acrylates (BMA-200, 250, 300 from Bomar Specialties Co.); Acrylamidomethyl substituted cellulosic esters (Jaylinks JL-103M, 106E from Bomar Specialties Co.).

Polymeric acrylates are generally prepared from a reaction between a polyol polymer and a acrylic acid analog. Examples of some commercial available polymeric (meth)acrylates include, but not limited to, ELVACITE 4026 from Ineos, HRJ-14177 from Schenectady International.

2. Epoxide Functionality Compounds and Polyol for the Cationic and Hybrid Systems

The epoxide functionality materials that are used in the compositions are compounds that possess on average at least one 1,2-epoxide group in the molecule. By “epoxide” is meant the three-membered ring of the formula:

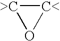

The epoxide functional materials can be monomers, oligomers or polymers and may have an aliphatic, aromatic, cycloaliphatic, araliphatic or heterocyclic structure; they comprise epoxide groups as side groups, or those groups from part of a alicyclic or heterocyclic ring system. It is preferred that the epoxide containing material comprise a least one liquid component such that the combination of material is liquid. Examples of suitable epoxy compounds include mono- and poly-glycidyl esters; mono- and poly-methylglycidyl esters; N-glycidyl compounds; S-glycidyl compounds.

Examples of suitable commercial epoxide containing compounds (resins and diluents) include, but not limited to, CYRACURE UVR-6105, 6110, 6128, 6000, 6100, 6216 from Dow/Union Carbide; UVACURE 1500, 1530, 1531, 1532, 1533, 1561, 1562 from UCB; CELOXIDE 2021P, 2081, 2083, 2085, 2000, 3000, glycidol, AOEX 24, CYCLOMER A200, M100, EPOLEAD GT-301, GT-302, GT-400, 401, 403 from Daicel Chemical Industries, Ltd.; EPICOAT 828, 812, 1031, 872, CT508 from Yuka-Shell Epoxy K.K.; KRM-2100, 2110, 2199, 2400, 2410, 2408, 2490, 2200, 2720, 2750 from Asashi Denka Kogyo Co; DVE-3, CHVE, PEPC from ISP; VECTOMER 2010, 2020, 4010, 4020 from Allied Signal/Moreflex Inc.; EPON 828, 1004, 1001F from Shell Chemical Co.; DER-332, DER-334 from Dow Chemical Co., Midland Mich.; ARALDITE epoxy line from Ciba-Geigy; CARCAT K126 from Sartomer.

Polyols are used to modify the properties of the cationic curable epoxy composition. Examples of poryols include branched, unbranched and cyclic diols such as ethylene glycol, 1,3-propylene glycols, 1,2-propylyene glycol, 1,4-butanediol, 1,3-butanediol. Some commercial polymeric polyols are available under the trade names TONE 0200, 0300 series from Dow/Union Carbide; and DYNAPOL S1401, S1402, S1358, S1359, S1227, S1229, S1313, and S1430 from Creanova, Inc. DYNAPOL S1227, S1229, S1358, S1401 and S1402 are hydroxyl terminated, saturated, linear semi-crystalline copolyesters. DYNAPOL S1313 and DYNAPOL S1430 are hydroxyl terminated, saturated, linear amorphous copolyesters.

A hybrid system comprises a combination of ingredients (containing ethylenic unsaturation and an epoxy/polyol combination) as listed in above cationic & free radical.

The second component of the radiation curable composition suitable for in-line printing is a photoinitiator. When the radiation source is visible light, ultraviolet light, and the like, one or more photoinitiators and/or photosensitizers can be used to initiate the polymerization reaction. Depending on the cure mechanisms, they can be classified into free radical type and cationic type initiators. In free radical cure systems, free radical initiators were used, whereas in cationic cure systems, cationic photoinitiators were be used. In hybrid systems, both free radical and cationic initiators are used. In the free radical curing system, no free radical initiator is required when the radiation source is electron beam, but at lease one cationic initiator is required to initiate the cationic curing systems or the cationic portion of a hybrid system.

Free radical initiators and sensitizers that are suitable for use in the present invention include, but are not limited to, the following compounds: 2,4,6-trimethylbenzoyl-diphenylphosphine oxide; TPO-L (one type of phosphine oxide from BASF); bis(2,4,6-trimethylbenzoyl)-phenylphosphine oxide; bis(2,6-dimethoxybenzoyl)-2,4,4-trimethylpentyl phosphine oxide; 1-hydroxycyclohexyl phenyl ketone; 2,2-dimethoxy-2-phenyl acetophenone; 2-methyl-1-[4-(methylthio)phenyl]-2-morpholinopropan-1-one; 2-hydroxy-2-methyl-1-phenyl-propan-1-one; 4-(2-hydroxyethoxy)phenyl-(2-hydroxy-2-methylpropyl) ketone; 2-benzyl-2-N,N-dimethylamino-1-(4-morpholinophenyl)-1-butanone; 2,2-(2,5-thiophenediyl)-bis-(5-tert-butylbenzoxazole); xanthone; fluorenone; anthraquinone; 3-methylacetophenone; 4-chlorobenzophenone; 4,4-dimethoxybenzophenone; 4,4-diaminobenzophynone; Michler's ketone; benzophenone; benzoin propylether; benzoin ethyl ether; benzyl dimethyl ketal; 1-(4-isopropylphenyl)-2-hydroxy-2-methylpropane-1-one; methylbenzoyl formate thioxanthone; diethylthioxanthone; 2-isopropylthioxanthone; and 2-chlorothioxanthone. Examples of commercially available free radical initiators include, IRGACURE 184, 369, 500, 651, 819, 907, 1700, 2959, 4265, DAROCURE 1173 (Ciba Geigy); LUCIRIN TPO, TPO-L (BASF), EBECRYL P36 and P37 (UCB Chemical Co.), polymeric photoinitiators KIP 100 and KIP150 (Lamberti). One or more free radical photoinitiators and/or photosensitizer can be incorporated in the composition in an amount of about 0.1 to 15% by weight in the binder, preferably 2-10 wt % in binder.

Cationic photoinitiators that are suitable for use in the composition and method of the invention include, but are not limited to, triaryl sulfonium hexafluorophosphate; aryl sulfonium hexafluoroantimonate; aryl sulfonium hexafluorophosphate; bis(dodecylphenyl) iodonium hexafluoroantimonate; bis(4-dodecylphenyl) iodonium hexafluoroantimonate; diaryl iodonium tetrakis-(pentafluoro phenyl) borate; and other suitable “iodinium” salts, and the like. Examples of the commercial available cationic photoinitiators include UVI-6950, 6970, 6974, 6990, 6976, 6990 and 6992 (Dow/Union Carbide); FX-512 (3M); UV9390C and UV9380C (GE Silicones); CD-1010, 1011, 1012, SARCAT K185 (Sartomer); IRGACURE 261 (Ciba-Geigy); and UVACURE 1590 (UCB Chemical Co.).

When the hybrid system is utilized, care must be utilized in the selection of reactants. Basic compounds, such as amines, that may be useful in a typical free radical curing systems have to be avoided in the hybrid system, because they neutralize the Lewis acid generated from the cationic initiator upon irradiation to start the polymerization.

Optionally, a third component of the radiation curable composition of the present invention is a non-radiation curable compound. Thermal plastic acrylate polymers (such as ELVACITE 2013, 2014, 2016, 2028, 2044, 2051, 2556, 2550, 4026, 4036, 4400 from Ineos Acrylics, NEPCRYL B-725, B-728, B-735, B-804, B-805, B-813, B-814, B-817, B-1019 for Avecia; ACRYLOID B44s, B48N, B-66, B-67, B-72, B-84 from Rohm & Hass; ACRYLNAL 4F, 700L, LR8820 from BASF), vinyl chloride copolymers (such as UcarVMCA, VMCH, VAGH, VAGD, VAGF, UCARMAG 527, 569 for Dow/Union Carbide; LAROFLEX MP 15, 25, 35, 45 from BASF and variation of the like vinyl copolymers), sulfonamides (such as SULFONEXO, E100, NX100 from Estron Chemical), polymer polymers, nitrocellulose (Such as ParCell R-10 cps, 20 cps, 30cps, ¼ sec, ½ sec from Green Tree Chemical Technologies), and other solid or liquid non-crosslinked polymers.

Other components that are suitable for use in the composition and method of the present invention include but are not limited to, NORSOLOENE S85, S95, S105, S115, S125, S135, S-145 from Sartomer; PICCOTEX 75, LC, 100, PICCOCLASTIC A5, A75, KRISTALEX 3070, 3085, 3100, 3115, 1120, and FORAL 85, 105 from Eastman Chemicals.

Plasticizers that are suitable for use in the composition and method of the present invention include, but are not limited to, dibutyl phthalate; diethyl phthalate; dioctyl phthalate; tributyl phosphate; tricresyl phosphate; triphenyl phosphate; triethyl cititrate; acetyltriethyl citrate; tri-n-butyl citrate; acetyltri-n-butyl citrate; acetyltri-n-hexyl citrate; benzoate esters such as Benzoflex 50, 9-88, 352 and CG (from Velsicol); SANTICIZER 97, 140, 141, 143, 148, 154, 160, 261, 278, 334F, 409 from Solutia; and polymeric plasticizers such as Admex-433, 515, 522, 523, 525, 762 (from Velsocol).

Other components that are suitable for use in the composition and method of the present invention, include additives for assisting the properties of the composition such as wetting/leveling, defoaming, dispersion of magnetic pigment, rheology, thermal stability, surface slip, and other properties that affect the performance of a uncured and cured composition.

Volatile components should be less than 80% by weight of the binder, preferably less than 15 wt %, most preferably less than 2 wt %. Any solvent that is compatible with or that can dissolve the components listed above can be used as a solvent/diluent, except when cationic system or hybrid system is involved where alcohols will become the reactants. Examples of the solvents include but not limited to:

Alcohols: isopropyl alcohol, n-propyl alcohol, n-butyl alcohol, isobutyl alcohol, ethanol, ethylene glycol, and propylene glycol.

Ketones: acetone, methyl ethyl ketone, methyl isobutyl ketone, and methyl amyl ketone.

Esters: methyl acetate, ethyl acetate, propyl acetate, isopropyl acetate, n-butyl acetate, glycol ether DB, glycol ether EB.

Glycol Ethers: ethylene glycol methyl ether, ethylene glycol ethyl ether, diethylene glycol methyl ether, diethylene glycol ethyl ether, and propylene glycol ethyl ether.

Aromatic Hydrocarbons: toluene, benzene and xylene.

Aliphatic petroleum naphthas: hexane, heptane, octane, VM& P naphtha, and mineral spirit.

Chlorinated solvents: methylene chloride, ethylene chloride, 1,1,1-trichloroethane; 1,1,2-trichloroethane.

Coating Application Methods:

In its second aspect, the present invention is directed to a method for selectively applying a magnetic surface to a non-magnetic substrate, comprising:

a. combining magnetic particles having an average size within the range of 1μ to 200μ, with a radiation curable resin to form a radiation curable magnetic coating composition;

b. pattern applying a layer of the radiation curable magnetic coating composition directly to a predetermined portion of a surface of a non-magnetic substrate, the layer having a thickness within the range of 0.4 mils to 20 mils upon curing.

In the above method, the magnetic particles (as previously described herein) preferably have an average size within the range of 10μ to 80μ; more preferably, an average size within the range of 20μ to 70μ.

The radiation curable magnetic coating composition is pattern applied by any process that is suitable for in-line printing. By way of example, these methods include, but are not limited to, flexo-, roller-, blanket-, Gravure-, silk screen-, rotary screen-, slot die-, vacuum-, curtain-coaters and the alike. In each of the above methods, the magnetic coating should have a suitable viscosity range that is appropriate to each coating method. Preferably, the method for applying the radiation curable magnetic coating composition of the present invention employs a rotary screen-, silk screen-, or flexo-coater. More preferably, the method for applying the radiation curable magnetic coating composition of the present invention employs a rotary screen coater. All of the above-described methods are well-known in the art of printing. For example, using a rotary screen coater, those skilled in the art recognize that one can control the thickness of the silk screen printing (dry emulsion) by controlling the mesh size of the screen and the thickness of the emulsion layer or photopolymer layer. A preferable screen mesh size is 50 to 120 lines/inch and a preferred dry emulsion thickness is 20 to 100μ (0.8 to 4 mils).

Generally, the radiation curable magnetic coating composition of the present invention is applied (most preferably, pattern applied) to a non-magnetic substrate at a coating thickness of 0.4-20 mils (10 to 500μ), more preferably 2-10 mils (50 to 250μ), most preferably 2-4 mils (50 to 100μ). Possible variations, and applications of the processes of the above mentioned coating application methods include, but not limited to, the related topics listed in “Package Printing”, Nelson R. Eldred, Ph.D., Jelmar Publishing Co., Inc. (1993) for Flexo, Gravure, Screen, Rotary Screen, Curtain, and other methods; “Flexography: Principle and Practices”, 4^{th} Edition. Frank N. Siconolfi. Flexographics Technical Association, Ronkonkoma, N.Y. (1991) and “Handbook of Pressure-Sensitive Adhesive Technology”, Don Satas, VanNortrand Reinhold Company, New York (1982) for Roller, gravure, Slot-Orifice (Slot-die), and other methods; “Coating Equipment and Processes”, G. L. Booth, New York, Lockwood Publishing Co. Inc. (1970); “Coating and Laminating Machines”, H. L. Weiss, Converting Technology Co., Wis. (1977) for coating equipment and machines. The coating methods also include but not limited to those listed in the following patents: roller (U.S. Pat. No. 5,997,205, U.S. Pat. No. 5,607,728), blanket- (U.S. Pat. No. 5,148,742, U.S. Pat. No. 5,107,790, U.S. Pat. No. 4,569,306 and U.S. Pat. No. 4,524,712), gravure- (U.S. Pat. No. 5,681,389, U.S. Pat. No. 5,608,969, U.S. Pat. No. 5,126,531), silk screen- (U.S. Pat. No. 4,030,444), rotary screen- (U.S. Pat. No. 5,698,034), slot die- (U.S. Pat. No. 5,611,859), vacuum- (U.S. Pat. No. 5,753,342), curtain- (U.S. Pat. No. 5,976,630, U.S. Pat. No. 5,843,531, U.S. Pat. No. 5,759,633, U.S. Pat. No. 6,294,023 and U.S. Pat. No. 6,103,313) coaters. All of the publications and patents disclosed herein are incorporated by reference herein in their entirety.

In the above-described method, the radiation curable magnetic coating composition generally has a viscosity within the range of 100 centipoises (cps) to 50,000 cps. However, the viscosity is dependent upon the coating method employed to implement the pattern applying step recited above. Examples of the viscosity ranges radiation curable magnetic coating compositions as a function of the coater method are listed in Table 1 below:

TABLE 1
Viscosity Ranges

| Coater | viscosity range | More preferred | Most preferred |
|---|---|---|---|
| Flexo | 200-3500 | 500-3000 | 500-2000 |
| Roller | 200-10,000 | 500-6000 | 600-4000 |
| Blanket | 200-20,000 | 500-6000 | 600-4000 |
| Gravure | 100-2500 | 500-2000 | 1000-1500 |
| Silk screen | 300-50,000 | 500-10,000 | 1000-4000 |
| Rotary screen | 300-50,000 | 500-6000 | 1000-4000 |
| Slot die | 300-30,000 | 500-10,000 | 600-4000 |
| Vacuum | 100-10,000 | 300-7000 | 500-3000 |
| Curtain | 100-30,000 | 300-6000 | 500-4000 |

In its third aspect, the present invention is directed to a method for making an adhesive-free laminated product that adheres by magnetic attraction to an iron based surface, comprising:

a. combining from 50 to 95 weight % of magnetic particles having an average size within the range of 1μ to 200μ, with 50 to 5 weight % of a radiation curable resin, and an effective amount of a curing agent, to form a radiation curable magnetic coating composition;

b. pattern applying a layer of the radiation curable magnetic coating composition directly to a predetermined portion of a surface of a non-magnetic substrate; and

c. curing said pattern applied radiation curable magnetic coating composition to form a laminated product having a magnetic coating adhered to a predetermined portion of said non-magnetic substrate.

In the above described method, the components are as already described herein. The pattern applying step is as described above. Preferably, before, during or after said curing step, said magnetic particles in said radiation curable magnetic coating composition are magnetically charged to increase the strength of their magnetic field. If necessary, the magnetic pigment particles of the pattern applied composition are pre-aligned before the curing step.

Radiation curable composition can be cured by ionizing radiation sources including Ultraviolet light (UV) sources such as medium pressure mercury vapor lamps, microwave powered electrodeless lamps and their variation (e.g. doped, ozone free, pulsed bulb) and electron beam (EB) radiation.

For a cure thickness lower than 5 mils, a UV light source is preferred. More preferably, curing is performed with one or more doped lamps that enhance the cure depth e.g., a V-bulb for electrodeless lamps (Fusion UV curing systems from Fusion Systems Corp. -Gaithersburg, Md.), or a Gallium-doped bulb for medium pressure mercury vapor lamps. Wattage of the lamps are preferably equal to and higher than 300 watt/inch and more preferably equal to and higher than 400 watt/inch or most preferably equal to and higher than 600 watt/inch.

For cure thickness equal to and higher than 5 mils, electron beam curing will be more preferable. The voltage of the radiation beam and curing dosage will match the thickness of the applied film. The voltage will be higher than 110 KV and more preferably higher than 165 KV. The curing dosage will be higher than 2 Mrads and preferably more than 3 Mrads.

In various embodiments of the above described method, a finishing step delivers the final piece in a simple sheet with die cut magnets, or creates an “integrated magnet” format by plow folding over the magnet panel, pattern coating or flood coating an adhesive that will only adhere the non-magnet matrix areas between die cut magnets, thus, allowing for the individual magnets to be “popped” out of the carrier by the final end user.

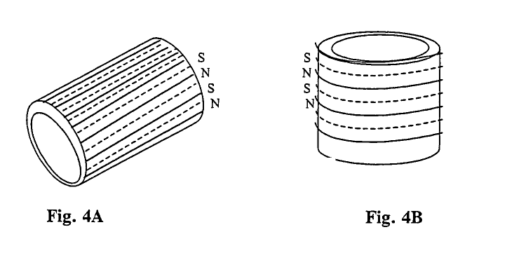

Magnetizing the radiation curable (or cured) magnetic coating film is performed, or charged through direct contact to a suitable type of charging magnets with single-pole or multi-pole charging arrangement, preferably with multi-pole arrangement. The effect of multi-pole magnetization on the magnetized sample depends on the pole pitch and therefore, one can design the pole pitch for maximum holding performance. The preferred setup for the multi-pole charging arrangement is to assemble these charging magnets at the circumference of two idler type rollers with the web or sheet traveling in between for higher speed charging. Two of the possible multi-pole roller setups are shown in FIG. 4. The diameter of the charging roller will be designed to allow sufficient or maximum charging at a desirable line speed of the process. The charging magnets will include Sintered rare-earth type permanent magnets such as neodimium iron boron (NdFeB) and other variations as known the art of magnet charging.

In another aspect, the present invention is directed to a composite object comprising a non-magnetic substrate having at least one surface to which is directly adhered a layer of a radiation cured magnetic resin comprising 50 to 95 weight % of magnetic particles having an average size within the range of 1μ to 200μ, dispersed within 50 to 5 weight % of a radiation cured resin.

In the composite object and in the methods of the present invention, the particular non-magnetic substrate of the present invention is not critical and may be any suitable substrate known in the graphic art and flexible packaging industries. Examples of suitable substrate include, but are not limited to paper, paperboard, cardboard; polyester such as polyethylene terephthalate, polyolefins such as polyethylene or polypropylene; cellulose derivative such as cellulose triacetate; polymers such as polycarbonate, polyvinyl chloride, polyimide, polyphenylene sulfide, polyacrylate, polyether sulfone, polyether ketone; metals such as aluminum, copper; metallized films such as aluminized polypropylene, metallized paper such as aluminized paper; and other suitable materials.

The integrated magnets of the present invention are useful as refrigerator magnets; file cabinet magnets; direct marketing magnets for couponing; magnets to be included in telephone directories containing emergency access phone numbers for police, fire, and hospital; magnets that can be redeemed for a specified value at retail and wholesale establishments; and calendar magnets.

### EXAMPLE 1

### Preparation of an Integrated Magnet (A Composite Object) of the Present Invention Using a Radiation Curable Magnetic Coating Composition

| 1,6-hexanediol diacrylate (HDDA) | 6.91 wt % |
|---|---|
| PHOTOMER 5429 (polyester acrylate oligomer) | 0.97 wt % |
| Amine acrylate monomer | 1.45 wt % |
| (adducts of HDDA & diethanolamine) | |
| ITX (2-isopropylthioxanthone) | 0.10 wt % |
| IRGACURE 907 (from Ciba-Geigy) | 0.05 wt % |
| (2-methyl-1-[4-(methylthio)phenyl]-2-morpholinopropan- | |
| 1-one) | |
| TPO-L (initiator) (Phosphine oxide type from BASF) | 0.74 wt % |
| CN966J75 (SartomerCo.) (polyurethane acrylate | 1.38 wt % |
| oligomer) | |
| MQP-S-9-8 (Magnequench Int., Inc.) | 88.40 wt % |
| (isotropic, spherical NdFeB magnetic powder) | |
| Total | 100.00% |

The binder portion, consisting of the above listed components with the exception of the magnetic particles, was made first by combining the components with mixing. Then, the rare-earth magnetic material, MQP-S-9-8, was mixed in just before use. The resulting radiation curable magnetic composition was applied on both 10 lb C1S paper stock and on polypropylene film laminated substrate with the application methods to the approximate thickness specified below.

Wire wound rod #20 - - - approximately 2 mils thick layer.

Wire wound rod #25 - - - approximately 2.5 mils thick layer.

Wire wound rod #30 - - - approximately 3 mils thick layer.

Screen (80 mesh screen & 50 microns thick emulsion - - - approximately 4 mils thick layers.

The coated samples were then cured with UV curing units equipped with medium pressure mercury lamp (H-Bulb in AETEK's curing system model# QC120244ANIR) or electrodeless doped bulb (V-bulb in Fusion's LC-6 system). The cure energy range for H-bulb with an AETEK International (Plainfield, Ill.) curing system is at 150 mJ/cm² (UVA range) and above for 2 to 3 mils samples with minimum of 300 watt/in setting. The cure energy range for V-bulb system with Fusion's curing system is 750 mJ/cm² (UVV range) and above for 2 to 4 mils thick samples. These samples were then magnetized with a magnetizer using a sintered NdFeB permanent magnet with multipole arrangement of 2 mm pole pitch. The prepared integrated magnet, having a thickness above 2.5 mils, showed good holding power for the intended application.

### EXAMPLE 2

### Preparation of an Integrated Magnet (A Composite Object) of the Present Invention Using a Radiation Curable Magnetic Coating Composition

A radiation curable magnetic composition comprising the following components was prepared according to the process described in Example 1:

| 1,6-hexanediol diacrylate (HDDA) | 6.91 wt % |
|---|---|
| PHOTOMER 5429 | 0.97 wt % |
| Amine acrylate | 1.45 wt % |
| (adducts of HDDA & diethanolamine) | |
| ITX (2-isopropylthioxanthone) | 0.10 wt % |
| IRGACURE 907 | 0.05 wt % |
| TPO-L (BASF) | 0.74 wt % |
| CN966J75 (SartomerCo.) | 1.38 wt % |
| MQP-S-11-9 (Magnequench Int., Inc) (isotropic, | 88.40 wt % |
| spherical, NdFeB magnetic powder | |
| with slightly higher energy output than S-9-8) | |
| Total | 100.00% |

The resulting radiation curable magnetic composition was then applied on 10 lb C1S paper stock with a wire wound rod #30 to approximately 3 mils thick and cure with both AETEK's unit and Fusion unit and similar cure energy as mentioned in Example 1. The prepared paper magnet samples are then magnetized with the same magnetizer used for Example 1. The samples were adequate for the intended application.

### EXAMPLE 3

### Preparation of an Integrated Magnet (A Composite Object) of the Present Invention Using a Radiation Curable Magnetic Coating Composition

A radiation curable magnetic composition comprising the following components was prepared according to the process described in Example 1:

| 1,6-hexanediol diacrylate (HDDA) | 6.91 wt % |
|---|---|
| PHOTOMER 5429 | 0.97 wt % |
| Amine acrylate | 1.45 wt % |
| (adducts of HDDA & diethanolamine) | |
| CN966J75 (SartomerCo.) | 1.77 wt % |
| Paint additive #57 (Dow Corning) | 0.50 wt % |
| MQP-S-9-8 (Magnequench Int., Inc) | 88.40 wt % |
| Total | 100.00% |

The resulting radiation curable magnetic composition was then applied on 10 lb C1S paper stock with a wire wound rod #30 to approximately 3 mils thick and cure with a lab EB unit from Energy Sciences Inc. (Wilmington, Mass.) with curing dosage of 165 KV and 3 Mrad. The prepared paper magnet samples are then magnetized with the same magnetizer used for Example 1. The samples were adequate for the intended application.

### EXAMPLE 4

### Preparation of an Integrated Magnet (A Composite Object) of the Present Invention Using a Free Radical Cured Magnetic Resin Cmposition Having a Non-Reactive Resin (UV Cured)

A radiation curable magnetic composition comprising the following components was prepared according to the process described in Example 1:

| 1,6-hexanediol diacrylate (HDDA) | 6.90 wt % |
|---|---|
| ELVACITE 2016 (non-reactive acrylate | 0.47 wt % |
| solid polymer from Ineos Acrylics) | |
| PHOTOMER 5429 | 0.87 wt % |
| Amine acrylate | 1.31 wt % |
| (adducts of HDDA & diethanolamine) | |
| ITX (2-isopropylthioxanthone) | 0.09 wt % |
| IRGACURE 907 | 0.05 wt % |
| TPO-L (BASF) | 0.68 wt % |
| CN966J75 (SartomerCo.) | 1.23 wt % |
| MQP-S-11-9 (Magnequench Int., Inc) | 88.40 wt % |
| (isotropic, spherical, NdFeB magnetic powder | |
| with slightly higher energy output than S-9-8) | |
| Total | 100.00% |

The resulting radiation curable magnetic composition was then applied on 10 lb C1S paper stock with a wire wound rod #30 to approximately 3 mils thick and cured with the AETEK's unit mentioned in Example 1 and similar cure energy (150 mJ/cm²) at the UVA range. The prepared paper magnet samples are then magnetized with the same magnetizer used in Example 1. The samples were adequate for the intended application.

### EXAMPLE 5

### Preparation of an Integrated Magnet (A Composite Object) of the Present Invention Using a Cationic (Electron Beam (EB) Cured) System

The following radiation curable magnetic composition was prepared similar to the process as disclosed in Example 1:

| | |
|---|---|
| UVACURE 1531 | 5.34 wt % |
| (cycloaliphatic diepoxy resin/polyol blend from | |
| UCB Chemicals) | |
| UVACURE 1501 | 5.34 wt % |
| (cycloaliphatic diepoxy resin from UCB Chemicals) | |
| UVI-6974 | 0.92 wt % |
| (Triaryl sulfonium hexafluoroantimonate from | |
| Union Carbide/Dow) | |
| MQP-S-11-9 (Magnequench Int., Inc) | 88.40 wt % |
| (isotropic, spherical, NdFeB magnetic powder | |
| with slightly higher energy output than S-9-8) | |

The resulting radiation curable magnetic composition was then applied on 10 lb C1S paper stock with a wire wound rod #25 to #28 to approximately 2.5 mils thick and cure with a lab EB unit from Energy Sciences Inc. (Wilmington, Mass.) with curing dosage of 165 KV and 7 Mrad. The prepared paper magnet samples are then magnetized with the same magnetizer used for Example 1. The samples were adequate for their intended application.

### EXAMPLE 6

### Preparation of an Integrated Magnet (A Composite Object) of the Present Invention Using a Hybrid (EB Cured) System

The following radiation curable magnetic composition was prepared similar to the process as disclosed in Example 1:

| EBECRYL 3605 | 0.59 wt % |
|---|---|
| (Epoxy acrylate with epoxide functional group) | |
| PHOTOMER 5429 | 5.92 wt % |
| 2-phenoxyethyl acrylate | 1.18 wt % |
| 1,6-hexanediol diacrylate (HDDA) | 2.37 wt % |
| UVR-6110 | 1.18 wt % |
| (cycloaliphatic epoxide resin (from Union Carbide/Dow) | |
| UVL-6974 | 0.36 wt % |
| (Triaryl sulfonium hexafluoroantimonate from Union | |
| Carbide/Dow) | |
| MQP-S-11-9 (Magnequench Int., Inc) | 88.40 wt % |
| (isotropic, spherical, NdFeB magnetic powder | |
| with slightly higher energy output than S-9-8) | |
| Total | 100.00% |

The resulting radiation curable magnetic composition was then applied on 10 lb C1S paper stock with a wire wound rod #30 to approximately 3.0 mils thick and cured with a lab EB unit from Energy Sciences Inc. (Wilmington, Mass.) with curing dosage of 165 KV and 3 Mrad. The prepared paper magnet samples are then magnetized with the same magnetizer used for Example 1. The samples were adequate for the intended application.

1. A radiation curable magnetic composition suitable for in-line printing comprising from 50 to 95 weight % of magnetic particles having an average particle size ranging from 1 micron (μ) to 200μ, in combination with 50 to 5 weight % of a radiation curable resin, said radiation curable magnetic composition having a viscosity within the range of 50 cps to 10,000 cps at in-line printing temperatures.

2. The composition of claim 1 comprising from 80 to 90 weight % magnetic particles.

3. The composition of claim 1, wherein the magnetic particles have an average size ranging from 10μ to 80μ.

4. The composition of claim 1, wherein the magnetic particles comprise a rare earth alloy.

5. (Cancelled)

6. The composition of claim 1, wherein the radiation curable resin utilizes a free radical cure system, a cationic cure system or a hybrid free radical/cationic cure system.

7. The composition of claim 6, wherein the radiation curable resin utilizes a free radical cure system.

8. The composition of claim 7, wherein the free-radical cure system employs an acrylate, a methacrylate or a combination thereof.

9. The composition of claim 6, wherein the radiation curable resin utilizes a cationic cure system.

10. The composition of claim 9, wherein the cationic cure system employs an epoxide resin or a polyol resin.

11-19 (Cancelled)

20. A composite object comprising a non-magnetic substrate having at least one surface to which is directly adhered a printed layer of a radiation cured magnetic resin, said radiation cured magnetic resin comprising 50 to 95 weight % of magnetic particles having an average size within the range of 1μ to 200μ, dispersed within 50 to 5 weight % of a radiation cured resin.

21. The composite object of claim 20, wherein the magnetic particles having an average size within the range of 10μ to 80μ.

22. The composite object of claim 21, wherein the magnetic particles having an average size within the range of 20μ to 70μ.

23. The composite object of claim 20, wherein the layer of the radiation curable magnetic coating composition has a thickness within the range of 0.4 mils to 20 mils upon curing.

24. The composite object of claim 20, wherein the non-magnetic substrate is selected from the group consisting of paper, cardboard, wood, ceramic, plastic, aluminum and combinations thereof.

25. The composite object of claim 24, wherein the non-magnetic substrate is paper.

26. The composite object of claim 24, wherein the non-magnetic substrate is cardboard.

27. The composite object of claim 25, wherein the paper is a sheet of paper having opposing sides.

28. The composite object of claim 27, wherein at least one side of the sheet of paper has printing or indicia.

29. The composite object of claim 28, wherein the side of the sheet of paper that is opposite the layer of the radiation cured magnetic resin has printing or indicia thereon.
